(19) United States
(12) Patent Application Publication
(10) Pub. No.: US 2022/0384064 A1
(43) Pub. Date: Dec. 1, 2022

(54) Polymer Concrete for Integrated Radiation Shielding

(71) Applicants: Mahmoud Reda Taha, Albuquerque, NM (US); Eslam Mohamed Soliman, Albuquerque, NM (US)

(72) Inventors: Mahmoud Reda Taha, Albuquerque, NM (US); Eslam Mohamed Soliman, Albuquerque, NM (US)

(73) Assignee: UNM Rainforest Innovations, Albuquerque, NM (US)

(21) Appl. No.: 17/776,210

(22) PCT Filed: Nov. 11, 2020
(86) PCT No.: PCT/US2020/060043

§ 371 Date: May 11, 2022

Related U.S. Application Data
(60) Provisional application No. 62/933,828, filed on Nov. 11, 2019.

(51) Int. Cl. G21F 1/04; C04B 26/12; C04B 26/14; C04B 14/00; C04B 14/32

(52) U.S. Cl. CPC G21F 1/045; C04B 26/122; C04B 26/14; C04B 14/005; C04B 14/327; C04B 2111/00258

(57) ABSTRACT

A multi-functional polymer concrete using polymer or cement-polymer binders modified with boron nanotubes and heavyweight aggregate particles.

### RELATED APPLICATIONS

This application is a 371 National Phase of PCT/US2020/060043 filed on 11 Nov. 2020, which claims priority to U.S. Provisional Application No. 62/933,828 filed on 11 Nov. 2019, both of which are incorporated herewith in their entirety.

### DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure or system. Further, the terms and phrases used herein are not intended to be limiting, but rather to provide an understandable description of the invention.

In one embodiment, the present invention provides a new type of multi-functional polymer concrete for combined radiation shielding of gamma-ray, alpha-rays, neutrons and other types of radiation waves. In a preferred embodiment, the present invention provides a new class of nano-modified polymer concrete where thermoset or thermoplastic polymers in lieu of or mixed with cement are used as the binder (e.g. polyester, vinyl ester, polyurethane, styrene, phenolic resins, Epoxy resins, PEEK, ULTEM or other hydrogen-rich polymers, chitosan-based biopolymers, cellulose-based biopolymers, oil-based biopolymers, or cement-modified rich hydrogen polymers). The new polymer concrete mix incorporates Boron Nanotubes (BNTs) or Boron nitride nanotubes (BNNTs) particles or fibers and heavyweight aggregate (Bauxite, Barite, Ferrite, Granite, Boron, Hematite, Magnetite, Limonite, or other high-density aggregate with specific gravities above 3.5) as fillers. The new polymer concrete can shield against high and low energy radiations such as gamma and alpha rays using its heavyweight aggregate. The new concrete can also slow down, and scatter fast neutron rays using its rich hydrogen content from the polymer binder and captures the scattered (thermal) neutrons using BNTs or BNNTs.

In other aspects, the embodiments of the present invention may be used for structural and shielding applications eliminating the need for layered materials typically used for radiation shielding. In addition, the embodiments of the present invention may be used as repair material and coating to bond to existing deteriorated concrete in applications for nuclear and healthcare facilities. The new nano-modified polymer concrete has relatively high compressive strength (about 10,000 psi), high tensile strength and high strain at failure and fracture toughness compared with cement only based concrete used for radiation shielding.

The new nano-modified polymer concrete of the present invention has low permeability, low viscosity, excellent adhesion, high resistant to freeze and thaw cycles, and excellent durability as opposed to current cement-based shielding technology. The embodiments of the present invention are also designed to observe minimum creep under service level stresses.

When high-temperature polymers are used (e.g. PEEK or ULTEM), the new polymer concrete of the present invention can provide radiation shielding associated with elevated temperatures. The new polymer concrete of the present invention provides excellent material for structural applications while providing a simple method for radiation shielding against gamma and alpha rays as well as against neutrons without the need for multiple shielding layers.

The disclosure should therefore not be limited by the above described embodiments, methods, and examples, but by all embodiments and methods within the scope and spirit of the disclosure. In addition, to the above description, the materials attached hereto form part of the disclosure of this provisional patent application.

1-15. (canceled)

16. A polymer concrete comprising polymer or cement-polymer binders modified with boron nanotubes and heavyweight aggregate particles.

17. The polymer concrete of claim 16 wherein said aggregate particles are from the groups comprising Bauxite, Barite, Boron, Ferrite, Granite, Hematite, Magnetite, Limonite, or other high-density aggregate with specific gravities above 3.5,

18. The polymer concrete of claim 16 wherein said polymer incorporates Boron Nanotubes (BNTs).

19. The polymer concrete of claim 16 wherein said polymer incorporates or Boron nitride nanotubes (BNNTs) particles.

20. The polymer concrete of claim 16 further comprising heat-resistant polymers.

21. The polymer concrete of claim 20 wherein said heat-resistant polymers are from the group comprising Phenolic Resins, Epoxy resins, PEEK, or ULTEM.

22. An integrated radiation shield comprising: a panel, said panel comprised of a polymer concrete comprising polymer or cement-polymer binders modified with boron nanotubes and heavyweight aggregate particles.

23. The integrated radiation shield of claim 22 wherein said aggregate particles are from the groups comprising Bauxite, Barite, Boron, Ferrite, Granite, Hematite, Magnetite, Limonite, or other high-density aggregate with specific gravities above 3.5,

24. The integrated radiation shield of claim 22 wherein said polymer incorporates Boron Nanotubes (BNTs) or Boron nitride nanotubes (BNNTs) particles or fibers.

25. The integrated radiation shield of claim 22 further comprising heat-resistant polymers.

26. The integrated radiation shield of claim 25 wherein said heat-resistant polymers are from the group comprising Phenolic Resins, Epoxy resins, PEEK, or ULTEM.

27. A method of protecting against gamma and alpha rays and neutrons and to allow absorbing scattering neutrons without the need to multi-layered shielding material comprising the following steps:
providing a panel, said panel comprised of a polymer concrete comprising polymer or cement-polymer binders modified with boron nanotubes and heavyweight aggregate particles.

28. The method of claim 27 wherein said aggregate particles are from the groups comprising Bauxite, Barite, Boron, Ferrite, Granite, Hematite, Magnetite, Limonite, or other high-density aggregate with specific gravities above 3.5.

29. The method of claim 27 wherein said polymer incorporates Boron Nanotubes (BNTs) or Boron nitride nanotubes (BNNTs) particles or fibers.

30. The method of claim 27 further comprising heat-resistant polymers.

31. The method of claim 30 wherein said heat-resistant polymers are from the group comprising Phenolic Resins, Epoxy resins, PEEK, or ULTEM.
